(19) United States
(12) Patent Application Publication
(10) Pub. No.: US 2026/0340237 A1
(43) Pub. Date: Oct. 29, 2026

(54) CONSTRAINT-BASED BUILDING CORE AND STRUCTURAL DESIGN GENERATION SYSTEM

(71) Applicant: QBIQAI LTD, Tel Aviv (IL)

(72) Inventors: Elad Gilboa, Tel Aviv (IL); Elad Kaminer, Tel Aviv (IL); Leeor Solnik, Tel Aviv (IL)

(73) Assignee: QBIQAI LTD, Tel Aviv (IL)

(21) Appl. No.: 19/734,058

(22) Filed: Jul. 8, 2026

Related U.S. Application Data
(63) Continuation-in-part of application No. 18/415,735, filed on Jan. 18, 2024, now abandoned.
(60) Provisional application No. 63/440,938, filed on Jan. 25, 2023.

(51) Int. Cl. G06F 30/27; G06F 30/13; G06F 111/04; G06F 111/06

(52) U.S. Cl. CPC G06F 30/27; G06F 30/13; G06F 2111/04; G06F 2111/06

(57) ABSTRACT

A computerized architectural system for generating structurally feasible building designs. The system utilizes a topological model and a hybrid evaluation architecture to process candidate structural configurations. An automated multi-stage pruning mechanism evaluates structural-span and evacuation-route constraints, suppressing the generation of floor-plan objects for non-compliant configurations. This approach improves computational efficiency by reducing memory allocation and processing cycles, and facilitates the output of machine-readable data for structural manufacturing.

### RELATED APPLICATIONS

This application is a Continuation-In-Part (CIP) of U.S. Patent Application No. 18/415,735 filed on 18 Jan. 2024 which claims the benefit of priority under 35 USC §119(e) of U.S. Provisional Patent Application No. 63/440,938 filed on 25 Jan. 2023, the contents of which are incorporated herein by reference in their entirety.

### FIELD AND BACKGROUND OF THE INVENTION

The present invention relates to computerized architectural design systems and, more particularly, to systems for generating structurally compliant building configurations and building core arrangements subject to physical and regulatory constraints.

United States Patent No. 11972174 appears to disclose, “Automated design for buildings or portions of buildings and machine-generate architectural design and floor plans. Computer-implemented systems and methods of designing multi-unit buildings and portions of buildings include a set of one or more input requirements, a relationships module, an options placement system, a layout predictor system, and a design plan generator. The input requirements include one or more pre-defined footprints and may include local regulatory requirements such as building code, zoning, accessibility, among others. The design plan generator generates an architectural design plan for the building or portion of a building that can be built on the one or more pre-defined footprints. Disclosed systems and methods substantially reduce the design time and cost while increasing the profitability, sustainability and efficiency of construction projects.”

United States Patent No. 12430479 appears to disclose, “A computer-aided system and associated method for automated building design includes receiving input parameters and generating a three-dimensional parametric computer model of a building frame and populating the three-dimensional computer building model with generic and manufacturer-specific products by accessing internal and external data sources. The populated computer model calculations and simulations are used to analyze regulatory compliance, verify engineering requirements including load calculations, and evaluate cost considerations. Based on simulation results, the method generates output documents including requests for proposals (RFP documents) for contractors, requests for quotations (RFQs) for vendors, and regulatory compliance documentation. These documents are transmitted to respective stakeholders through a secure data exchange protocol. The method further includes receiving responses to the generated RFP documents/RFQs.”

United States Patent Publication No. 2023/0008905 appears to disclose an approach that "automatically generates an optimized building structure design given a set of building design parameters including a specified interior layout. The generated building structure design determines floor plate sizing, beam sizing, column sizing, any needed lateral system, and connectors between the determined building element, which are then displayed to the building structure designer for review, and which facilitates customization as desired by the building structure designer. Some or all of this process can then be repeated when building design parameters are changed thereby facilitating automated and iterative building structure design as differing design parameters and resulting optimized building structure designs are considered."

United States Patent No. 12430477 appears to disclose " a grid-based design application automatically generates a design for a structural system of a building. In operation, the grid-based design application generates a structural grid based on a region within a computer-aided design of the building. Subsequently, the grid-based design application applies the structural grid to the region to generate a gridded region. The grid-based design application computes a set of spanning directions based on the gridded region. The grid-based design application then generates at least a portion of the design for the structural system based on the set of spanning directions and the gridded region.”

Korean Patent Application No. KR20140092431 appears to disclose " a vertical zoning method of a high-rise building planning step and a device thereof. The vertical zoning method of a high-rise building planning step, for a computer terminal device, includes the steps of: receiving basic information about an initial step of high-rise building planning, determining the number of the entire vertical zoning according to a combination type of an elevator based on the received basic information, and determining improved vertical zoning according to the number of the entire vertical zoning.”

Additional, art relating to architectural design is United States Patent Publication No. 2005/0114095, United States Patent Publication No. 2016/0040443, United States Patent Publication No. 2021/0150091, International Patent Publication No. 2005/114495, United States Patent Publication No. 2022/0083703.

### SUMMARY OF THE INVENTION

In some embodiments, the present disclosure relates to computerized systems and methods for generating structurally feasible and regulation-compliant building designs using computational evaluation of multiple candidate structural building configurations and candidate building core configurations. A computing system may receive machine-readable building information including intended building use data and one or more structural, regulatory, environmental, and spatial constraints. The computing system may generate multiple candidate building core configurations and corresponding candidate structural building configurations, evaluate the generated configurations according to one or more building constraints, eliminate candidate configurations violating one or more constraints, generate floor plans derived from corresponding structural geometries and spatial configurations, and output one or more structurally feasible building designs.

In some embodiments, candidate building core configurations may include centralized core configurations, decentralized core configurations, edge-positioned core configurations, and/or multiple-core configurations. The disclosed systems may iteratively modify structural parameters associated with candidate structural building configurations including structural grid spacing, floor height, support structure placement, circulation pathways, structural framework geometry, and building geometry. Generated candidate structural building configurations may be evaluated according to fire safety constraints, evacuation-route limitations, structural span limitations, wind-load constraints, seismic constraints, accessibility requirements, drainage constraints, zoning restrictions, and/or related engineering conditions.

In some embodiments, the disclosed systems may generate spatial configurations and, for surviving candidates, generate corresponding floor plans and candidate building core configurations using one or more computational evaluation and optimization routines. Candidate building configurations may optionally be ranked according to projected construction costs, operating efficiency, material utilization, energy efficiency, projected profitability, and/or related evaluation metrics. The disclosed systems may thereby facilitate computational exploration and evaluation of structurally distinct building configurations associated with alternative candidate building core arrangements.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

FIG. 1A is a block diagram illustrating a system for designing a building in accordance with an embodiment of the current invention.

FIG. 1B is a block diagram of an architectural of computing system configured to generate building designs in accordance with an embodiment of the current invention.

FIG. 2 is a flow chart illustration of a computer assisted method of designing building in accordance with an embodiment of the current invention.

FIG. 3 illustrates an example computational workflow 300 associated with generation of structurally feasible and regulation-compliant building designs.

FIG. 4: Flow diagram of a system, in accordance with an embodiment of the current invention.

FIG. 5: Flow chart illustrating a method of planning a building according to an embodiment of the invention.

FIG. 6: Block diagram of a system, in accordance with an embodiment of the current invention.

FIG. 7: A schematic illustration of the system, in accordance with some embodiments.

FIG. 8: A structural configuration evaluation workflow for generating structurally feasible and regulation-compliant building designs, in accordance with some embodiments.

FIG. 9: A hybrid computational evaluation architecture configured to evaluate and refine candidate building configurations using multiple computational analysis techniques, in accordance with some embodiments.

### DESCRIPTION OF SPECIFIC EMBODIMENTS OF THE INVENTION

The present invention relates to computerized architectural design systems and, more particularly, to systems for generating structurally compliant building configurations and building core arrangements subject to physical and regulatory constraints.

### OVERVIEW

In some embodiments, the present invention relates to computerized systems and methods for generating structurally feasible building designs using computational evaluation of interacting structural, spatial, environmental, and regulatory constraints. A computing system may receive machine-readable building information including occupancy requirements, site geometry data, zoning restrictions, fire safety requirements, accessibility requirements, environmental conditions, and structural limitations. The disclosed systems may generate and evaluate multiple candidate structural building configurations including multiple candidate building core configurations corresponding to different structural and spatial arrangements of a building. The generated configurations may be usable for architectural planning, structural analysis, evacuation analysis, regulatory-compliance analysis, and computerized building-design generation.

As used herein, "structurally feasible" refers to a candidate structural building configuration satisfying one or more structural criteria defined by applicable building constraint data. Such criteria may include structural span limitations, support-member stress limitations, support-column spacing requirements, lateral-load-resistance requirements, foundation requirements, wind-load requirements, seismic requirements, or combinations thereof.

In some embodiments, the disclosed systems implement a constraint-based computational model configured to process candidate building configurations according to interacting engineering and architectural conditions. The computing system may generate candidate structural building configurations including structural geometries, circulation pathways, support structures, spatial configurations, utility-routing regions, and evacuation routes associated with corresponding candidate building core configurations. Example candidate building core configurations may include centralized core configurations, decentralized core configurations, edge-positioned core configurations, peripheral core configurations, service core configurations, and multiple-core arrangements. Different building core configurations may affect structural feasibility, evacuation-route compliance, circulation geometry, accessibility compliance, support structure placement, and usable floor-area distribution associated with generated building configurations.

In some embodiments, the system comprises one or more processors configured to generate and evaluate candidate building configurations using machine-readable building data and building constraints. The system may generate multiple candidate building core configurations and corresponding structural building configurations, including alternative structural geometries, circulation arrangements, evacuation routes, support structures, and floor-plan arrangements.

In some embodiments, the system may utilize topological representations, constraint-processing routines, evaluation routines, and optimization routines to evaluate, refine, and filter candidate building configurations according to structural, spatial, environmental, and regulatory constraints. Candidate configurations violating one or more constraints may be excluded from further processing.

In some embodiments, the system outputs one or more structurally feasible building designs derived from surviving candidate building configurations, including corresponding floor plans, structural geometries, circulation layouts, and evacuation layouts.

In some embodiments, the disclosed systems perform iterative computational refinement of candidate structural building configurations using rule-based evaluation and optimization routines. The computing system may iteratively modify structural parameters including structural grid spacing, floor height, circulation pathways, support structure placement, structural framework geometry, building geometry, and building core placement. Generated candidate structural building configurations may be evaluated according to structural constraints, zoning restrictions, evacuation-route limitations, fire safety requirements, seismic constraints, wind-load conditions, accessibility requirements, drainage constraints, and environmental conditions. Candidate structural building configurations violating one or more building constraints may be eliminated prior to additional floor-plan generation or refinement operations. The disclosed systems may therefore facilitate computational exploration of structurally distinct building configurations that are impractical to evaluate manually due to the quantity of interacting structural variables and engineering constraints.

Some embodiments relate to an architectural computing system for generating structurally feasible and regulation-compliant building designs. The system and method facilitate evaluating structural, spatial, and circulation constraints within a topological model to perform automated, multi-stage pruning of candidate building configurations. Existing architectural software often fails to bridge the gap between high-level conceptual planning and structural feasibility, necessitating iterative manual refinement that is computationally expensive and slow. The system and method facilitate implementing a multi-stage filtering and topological evaluation architecture that permits the efficient exploration of structural and spatial design spaces. The system and method facilitate suppressing the generation of computationally intensive floor-plan objects for configurations that fail to meet predefined engineering and regulatory thresholds.

In some embodiments, the system utilizes a topological model that represents relationships among building components, e.g., cores, circulation regions, support structures, and usable floor areas. The system generates a plurality of candidate building core configurations and corresponding structural configurations. The structural configurations are evaluated using a hybrid computational architecture. The hybrid computational architecture coordinates multiple distinct analysis techniques, including graph-based connectivity evaluation, metric-based quantitative assessment, machine-learning-driven prediction, and optimization-routine refinement. By integrating these techniques within a unified topological model, the system represents complex spatial relationships that are not inherently captured by traditional grid-based CAD systems. The spatial relationships include the interaction between core structural stiffness and egress travel-distance limits, etc.

In some embodiments, generated candidate structural building configurations are evaluated according to one or more building constraints. The building constraints may include fire safety constraints, evacuation-route limitations, structural span limitations, zoning restrictions, wind-load constraints, seismic constraints, foundation constraints, drainage constraints, environmental conditions, accessibility requirements, construction requirements, and occupancy requirements. Candidate structural building configurations violating one or more building constraints may be eliminated prior to further processing.

In some embodiments, to ensure comprehensive exploration of the architectural solution space, the system maintains a diversity set of surviving core configurations. A candidate configuration is preserved in this set if its structural-load-distribution profile exhibits a variance above a threshold value relative to existing configurations. This facilitates the system simultaneously evaluating both centralized and decentralized core strategies. In some embodiments, structural feasibility evaluation may include determining whether calculated stress levels within defined support members remain below material-specific yield-strength thresholds. Furthermore, 'evacuation-route compliance' is defined as a state where the egress graph identifies at least one path from every node, representing a usable area, to an exit node with a total path length L < Lₘₐₓ, where Lₘₐₓ is a jurisdiction-specific travel distance limit.

The disclosed systems may therefore reduce processing associated with infeasible structural building configurations and facilitate automated evaluation of building configurations that are impractical to evaluate manually.

In some embodiments, floor plans are generated from corresponding structural geometries and spatial configurations of surviving candidate structural building configurations. The generated floor plans may define positional relationships between structural elements, circulation pathways, support structures, utility-routing regions, and usable floor areas associated with corresponding building core configurations. The disclosed systems may therefore generate structurally feasible and regulation-compliant building designs using coordinated computational evaluation of multiple interacting structural, spatial, and regulatory constraints.

Some embodiments of the program may include algorithms to improve value prediction and/or efficiency of a building design by producing a high volume of potential layout plans using organizational program data. According to some embodiments, the program may include algorithms to improve and/or predict costs and/or profits for each possible building design. Optionally, the algorithms may improve long-term, medium-term and/or short-term outcomes such as profits and/or probability of events (e.g., positive or negative) based on future building steps and/or developments and/or foreseeable problems. For example, routines may automatically generate structurally distinct candidate building configurations corresponding to alternative building core arrangements. In some embodiments, generated floor plans may be derived from evaluated structural geometries rather than manually drafted conceptual layouts.

According to some embodiments, the program may generate multiple possible building plans prior to construction. Some embodiments of the program may generate building plans from the initial stages in the building process. For example, planning the foundation and/or framework and/or the core and/or the shell of a building. Additionally, or alternatively, the program may generate plans for further stages in the building. For example, dividing the floor plan according to changing needs, updated legislation, environmental impact reports, etc. Additionally, or alternatively, the program may generate plans for renovation plans of the building and/or part thereof. For example, dividing the space on each floor and/or the decoration plan.

According to some embodiments, multiple plans and forms for the building may optionally be planned and/or compared and/or presented to the user. Optionally, the multiple plans and forms for the building may include costs and revenue over time, potential problems, etc.

In some embodiments, the system implements a specialized computational pipeline designed to overcome technical bottlenecks in structural design by utilizing a multi-attribute data structure representing candidate building core configurations. Each core configuration data structure comprises a multi-attribute data structure of interrelated technical parameters. The parameters include core count, core centroid coordinates, vertical-shaft geometry, specific stair/elevator/service-shaft assignments, numerical values for core structural stiffness, or combinations thereof. The system executes an iterative, multi-stage generative process where the computing system generates a structural grid constrained by the specific technical parameters of the candidate core multi-attribute data structure. To facilitate computational efficiency and structural integrity, the system represents egress routes as a graph. The system evaluates each candidate configuration against jurisdiction-specific maximum travel-distance thresholds and material-specific maximum-span limitations.

In some embodiments, the system performs automated pruning of the candidate configuration space by executing a constraint-propagation routine that evaluates structural and egress requirements concurrently. In response to determining that a candidate structural building configuration violates a structural-span limitation and/or an evacuation-route travel-distance constraint, the one or more processors perform an operation to skip the generation of a high-complexity floor-plan object for that candidate. The operation effectively suppresses final floor-plan generation for candidates that are mathematically incapable of satisfying compliance requirements. This reduces memory allocation and/or reduces redundant computational cycles during the exploration of the structural design space. The system maintains a diversity set of surviving core configurations. The candidate preservation is determined by a comparative analysis of structural-load-distribution differences. The coordinated evaluation facilitates that output building designs are structurally feasible. In some embodiments, structural feasibility evaluation may include determining whether a candidate configuration satisfies a maximum unsupported-span threshold, a minimum support-column spacing threshold, and/or a lateral-load-resistance threshold defined by building constraint data.

### Iterative Structural Configuration Generation

In some embodiments, the system performs iterative generation and refinement of candidate building configurations using computational processing of structural, spatial, and regulatory constraints. The system may receive machine-readable data on construction conditions, constraints and objectives. Based on the received data, the system may generate a plurality of candidate structural building configurations including multiple candidate building core configurations. Each candidate configuration may include a corresponding structural geometry, spatial configuration, circulation layout, support structure arrangement, and/or evacuation layout.

In some embodiments, the system generates multiple building core configurations and for each core configuration different structural and spatial arrangements of the building. Example core configurations may include centralized cores, decentralized cores, peripheral cores, service cores, multi-core arrangements, cast-on-site cores, prefabricated cores, steel-frame cores, and/or hybrid core arrangements. Each building arrangement may define corresponding circulation paths, support structures, utility-routing regions, evacuation routes, and usable floor areas. The generated building core configurations building arrangements may therefore affect structural feasibility, accessibility compliance, fire safety performance, and spatial efficiency of the resulting building structure.

In some embodiments, the system generates candidate building designs using one or more generative routines, parametric routines, rule-based routines, optimization routines, and/or iterative evaluation mechanisms. The generation process may include modifying one or more structural parameters associated with candidate building configurations. Example parameters may include core placement, core geometry, structural grid spacing, support structure placement, circulation pathways, floor height, floor-plan organization, number of floors, structural framework geometry, and/or building geometry. The system may generate multiple structural variations for each candidate building core configuration to facilitate exploration of alternative structural and architectural arrangements. Routines may computationally explore a combinatorial space of candidate building core configurations and structural geometries using iterative constraint evaluation.

In some embodiments, generated candidate building configurations are evaluated according to one or more building constraints. The constraints may include fire safety constraints, evacuation-route limitations, zoning restrictions, wind-load constraints, seismic constraints, accessibility requirements, structural span limitations, drainage constraints, foundation constraints, environmental conditions, and/or commercial constraints. The system may evaluate whether generated configurations satisfy structural feasibility conditions and applicable regulations. For example, fire safety constraints defining maximum travel distance to exits may influence placement and number of building cores. Accessibility constraints may affect corridor dimensions and circulation layouts. Structural span limitations may affect structural grid spacing and support structure placement.

In some embodiments, candidate building configurations violating one or more constraints may be rejected or eliminated prior to further processing. For example, building configurations that fail structural feasibility evaluation, violate zoning restrictions, or fail evacuation-route analysis may be excluded from subsequent design-generation stages. The system may therefore reduce processing associated with infeasible structural configurations and facilitate efficient exploration of structurally feasible building designs.

In some embodiments, the system is configured to perform an automated filtering process. In the filtering process, candidate structural configurations are excluded prior to final floor-plan generation if they violate structural-span limitations, evacuation-route constraints, or other regulatory requirements. This pruning mechanism represents a technical improvement in the computation itself. The pruning mechanism reduces the memory allocation required for the generation of high-fidelity floor-plan geometries. The pruning mechanism reduces the processing cycles expended on evaluating configurations that are mathematically incapable of satisfying governing structural or safety constraints. The coordinated evaluation facilitates vetting of output building designs for engineering and compliance metrics before they are presented for further review.

In some embodiments, surviving candidate configurations may be ranked according to one or more evaluation metrics. As used herein, ‘evaluation metrics’ may include projected construction cost, projected long and/or short-term profitability, operating efficiency, occupancy efficiency, spatial efficiency, construction speed, compliance quality, material utilization, energy efficiency, and floor-use suitability.

In some embodiments, the system iteratively refines surviving candidate building configurations through repeated cycles of generation, evaluation, elimination, ranking, and selection. The refinement process may preserve structurally and spatially distinct candidate configurations to facilitate exploration of multiple alternative design strategies. Floor plans generated for each surviving candidate configuration may be derived from corresponding structural geometries and building core arrangements. The resulting building designs may therefore correspond to structurally feasible and regulation-compliant configurations generated using computational evaluation of multiple interacting structural, spatial, and regulatory constraints.

By way of example, in one embodiment, the system receives as input a parcel polygon defining a 50m x 50m site, an occupancy type corresponding to commercial office use, and a maximum travel distance constraint of 45m. The system generates a candidate core configuration by enumerating core centroids on a grid within the perimeter envelope. For each centroid, the system calculates the shortest path from the furthest occupancy node to an exit node and compares the result to the 45m maximum travel distance. If the calculated shortest-path exceeds this threshold, the candidate core configuration is tagged as non-compliant and discarded from the iterative pool prior to the generation of a floor-plan object, thereby preventing the unnecessary consumption of computational resources

### Technical Advantages

In some embodiments, the disclosed systems improve computerized architectural design generation by enabling coordinated computational evaluation of multiple interacting structural and regulatory conditions affecting building feasibility. Conventional architectural workflows frequently require manual comparison of alternative building arrangements across numerous independent technical requirements. Such workflows may become impractical when evaluating large numbers of possible building core arrangements, circulation layouts, structural geometries, and floor-plan configurations simultaneously. The disclosed systems facilitate automated processing of these interacting technical constraints using computational generation and evaluation of candidate structural building configurations.

In some embodiments, the disclosed systems improve processing efficiency by reducing evaluation of infeasible candidate building configurations during intermediate stages of structural design generation. Candidate structural building configurations that violate selected building constraints may be eliminated prior to additional floor-plan generation, structural refinement, or further computational analysis.

Unlike conventional architectural systems that generate comprehensive spatial configurations for all generated structural options, the present system utilizes the aforementioned pruning logic to mitigate the combinatorial explosion of the design space. By eliminating infeasible candidates at the structural-topology stage, the system reduces the input/output (I/O) and memory operations required for rendering high-fidelity geometric data. The system increases the processing efficiency of the computing system.

In some embodiments, the disclosed systems may therefore reduce processing associated with structurally infeasible, non-compliant, or spatially incompatible building configurations. This may improve computational efficiency associated with exploration of large structural design spaces containing numerous possible building core arrangements and structural geometries. Early elimination of infeasible candidate structural building configurations may reduce memory utilization and repeated constraint-evaluation operations associated with generation of large structural design spaces. Intermediate filtering of infeasible candidate configurations may reduce iterative processing associated with structurally incompatible building arrangements.

In some embodiments, the disclosed systems improve generation of technically feasible building structures by computationally coordinating relationships between building core arrangements, circulation layouts, evacuation routes, support structures, and usable floor areas. Changes to one structural parameter may affect multiple interacting structural and regulatory conditions simultaneously. For example, modification of a building core arrangement may affect evacuation-route compliance, accessibility compliance, support structure placement, and floor-plan organization. The disclosed systems facilitate coordinated computational evaluation of such interacting structural relationships during generation of candidate building configurations.

In some embodiments, the disclosed systems improve computerized processing of structural and spatial building information by generating floor plans from corresponding structural geometries and spatial configurations. The resulting floor plans therefore correspond to evaluated structural building configurations rather than independently generated conceptual layouts. This coordinated generation process may improve consistency between structural geometry, circulation pathways, support structures, and usable floor areas associated with generated building designs.

In some embodiments, the disclosed systems facilitate computational exploration of structurally and spatially distinct building core configurations that are impractical to evaluate manually due to the number of interacting variables and constraints. Multiple candidate building core configurations may be evaluated according to different structural, regulatory, environmental, and spatial conditions while preserving corresponding structural geometries and circulation arrangements associated with each candidate configuration.

In some embodiments, the system outputs machine-readable structural specifications directly compatible with automated fabrication and construction systems, e.g., computer numerical control (CNC) machinery and/or additive manufacturing systems. The system facilitates directly executable output data by physical manufacturing systems by generating designs that are vetted through multi-stage topological pruning. The system transforms conceptual architectural input into actionable, physical structural instructions.

In some embodiments, the structural design space defined by varying core arrangements, grid spacings, and spatial constraints is characterized by a combinatorial explosion of possible candidate configurations. The system utilizes the multi-stage pruning logic described herein to constrain the search space. The system effectively manages memory allocation in a manner that is not practical for manual architectural design workflows. This represents a technical improvement in the computational management of structural engineering data.

### SPECIFIC EMBODIMENTS

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Reference is now made to the figures.

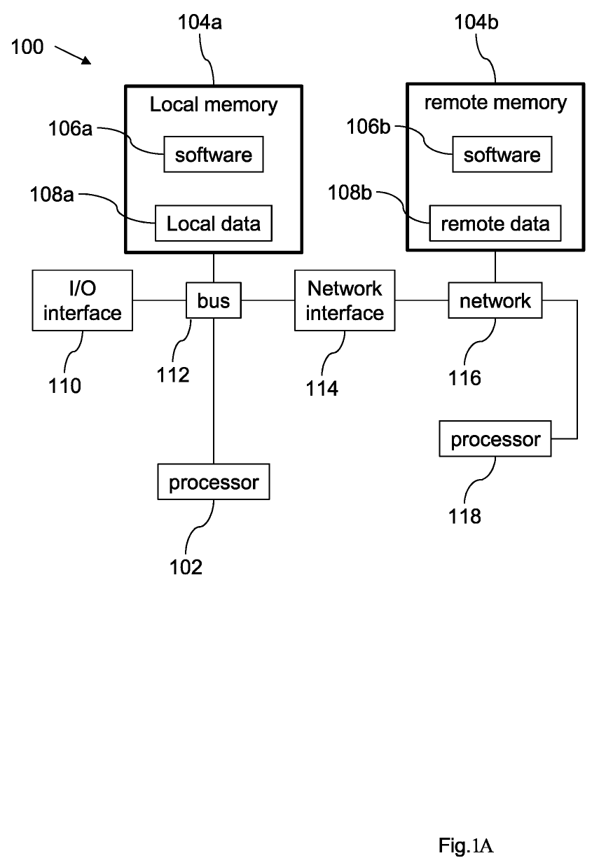

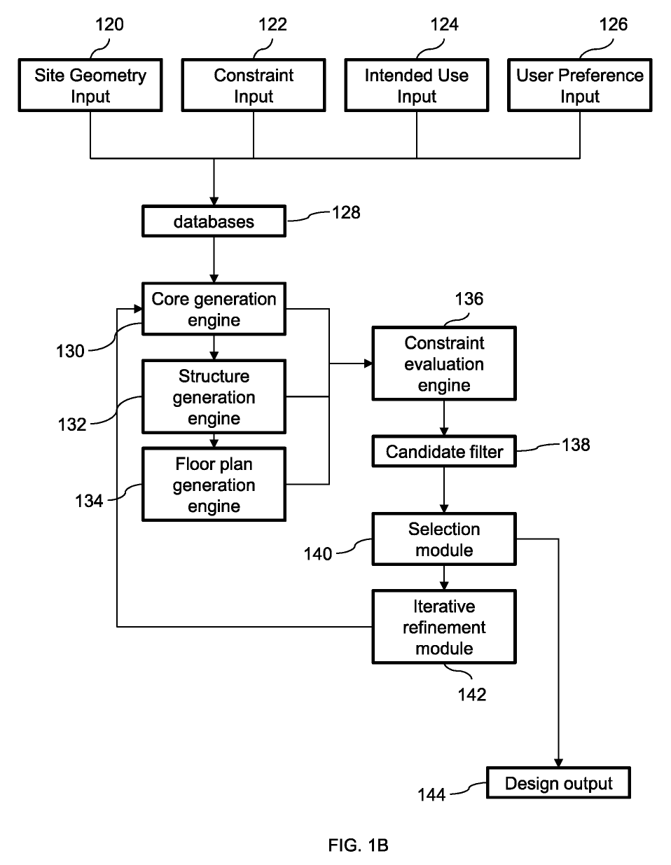

FIG. 1A is a block diagram illustrating a system for designing a building in accordance with an embodiment 100 of the current invention. In some embodiments, a processor 102 is connected via data bus 112 to a local memory 104a. For example, the local memory may store software 106a and/or data 108a. Alternatively or additionally, the data bus 112 may connect the processor to a network interface 114 that may connect to a network 116 and/or network resources, for example, network memory 104b and/or a network processor 118. For example, the local memory may store software 106a and/or data 108a. Optionally, the system may make use of a remote processor 118.

In some embodiments, software 106a and/or software 106b may include design software for designing building parts for example, there may be a module for designing key components of the building. For example, there may be a module to design the main structure of the building. The main structure optionally encompasses the foundation and/or footings, which, for example, distribute the weight of the building across the ground. Additionally or alternatively, the main structure may include a core. The core optionally contains shared services like elevators, staircases, and utility shafts. Optionally, the core may provide structural stability and/or accommodate vertical transportation within the building. Additionally or alternatively, the main structure may include a framework of the building. For example, the framework may include columns, (e.g., providing vertical support) and/or beams and/or girders (e.g., forming the horizontal network, supporting floors and transferring loads to the columns). Additionally or alternatively, the main structure may include a shear wall and/or diagonal bracing, (for example, to resist horizontal forces such as wind or seismic activity). Additionally or alternatively, the main structure may include the main structure of the building may incorporate mechanical, electrical, and plumbing systems integrated within the structure to support the building's functionality.

In some embodiments, software 106a and/or software 106b may include design software for designing aesthetic aspects of the building. For example, aesthetic aspects may include a building's shell. Optionally the shell includes exterior walls, façades, and cladding materials. These elements not only shield the structure from the elements but also contribute to its aesthetics.

In some embodiments, software 106a and/or software 106b may include design software for designing reconfigurable aspects of a building. For example, the module may design a floor plan. For example, the module may define purposes for rooms or accommodating additional functionalities. The floor plan may include allowance for future reconfiguration. Optionally, the module may design electrical connections. The module may also include contingencies for adjustments to support technological advancements or changes in power distribution needs, with the integration of new outlets, lighting fixtures, or upgraded wiring. Optionally, the module may design plumbing. In some embodiments, plumbing systems might be designed to permit reconfiguration to increase water efficiency, and/or accommodate additional fixtures, and/or address issues related to drainage. Optionally, the construction is designed for adaptive reuse, where existing structures are repurposed for different functions, for example, leading to alterations in ventilation, partitioning, and/or utility layouts. Optionally, the module includes advanced building technologies and/or modular construction techniques, for example to further facilitate reconfigurations, offering opportunities to enhance energy efficiency, technological integration, and/or overall building performance.

In some embodiments, software 106a and/or software 106b may include optimization software and/or cost accounting software and/or statistical software and/or artificial intelligence routines and/or financial software to e.g., determine the preferences of the designer and/or the cost benefit of various designs under various contingency scenarios and/or the likelihood that a structure will conform to constraints of the design. Additionally or alternatively, the software 106a and/or 106b may include specialized engineering modules such as three-dimensional design software (e.g., to output 3D models and/or specifications for ordering parts and/or equipment). Optionally, the system will include management software (for example, for planning and assisting with management of the building and/or predicting costs). Optionally, the system will include planning and organizing software (for example, for planning construction and/or organizing constructions). Optionally, the system will include imaging software. Optionally, the system will include software (e.g., searching software, automatic updating routines and/or artificial intelligence software) for accessing information.

In some embodiments, the local memory 104a and/or the remote memory 104b may include data 108a, 108b. For example, data 108a, 108b may include building constraints and/or preferences. For example, constraints may include local constraints such as external aesthetic constraints and/or building codes and/or laws. For example, preferences may include preferred use and/or requirements for use and/or alternatives uses and/or cost of adaptation and/or market predictions.

In some embodiments, the system will include an input and output (I/O) interface 110. For example, the interface may include human input/output devices such as keyboards, view screens, touch screens, data connections etc. Additionally or alternatively, the I/O interface may include specialized engineering modules. For example, the system may be connected to manufactures of building parts and/or suppliers of construction materials (e.g., to order parts and/or materials according to a building plan). For example, the system may connect to 3D printers to build 3D models. For example, the system may connect imaging systems to make presentations and images of the planned construction.

FIG. 1B illustrates an example architectural computing system configured to generate structurally feasible and regulation-compliant building designs through computational evaluation of multiple candidate building core configurations and corresponding structural building configurations. In some embodiments, the system may include interconnected computational modules configured to generate, refine, evaluate, filter, rank, and output candidate building designs according to structural, spatial, environmental, and regulatory conditions. The disclosed architecture may facilitate automated evaluation of candidate building configurations that are impractical to manually analyze due to the number of interacting structural variables and building constraints. The disclosed systems may facilitate computational evaluation of interacting structural variables impractical for manual architectural analysis. The quantity of interacting structural and regulatory conditions associated with candidate building core configurations may exceed practical manual evaluation capability.

The system may include a site geometry input 120 configured to receive or store geometric information associated with a building site. Example information may include plot geometry, property boundaries, topographical information, adjacent structures, terrain conditions, utility-access locations, road-access locations, easements, setback requirements, and allowable building envelopes. In some embodiments, the site geometry input 120 may provide geometric boundary data usable during generation of candidate building core configurations and structural layouts. Site geometry data may further influence circulation layouts, evacuation routes, structural grid spacing, and support structure placement.

Constraint input 122 may receive or store building constraint information associated with generation and evaluation of candidate building configurations. In some embodiments, the building constraints may include fire safety rules, evacuation-route limitations, accessibility requirements, structural span limitations, zoning restrictions, seismic requirements, wind-load limitations, environmental conditions, occupancy limitations, drainage requirements, soundproofing requirements, construction-speed requirements, and/or statutory regulations. The constraint input 122 may additionally receive mapping data, architectural requirements, and jurisdiction-specific building regulations. In some embodiments, the disclosed system may utilize rule-based processing routines to apply different categories of constraints during different stages of candidate building generation and refinement. Candidate building configurations may be represented using parametric geometric representations and machine-readable spatial relationship data. For example, structural relationships between support structures, circulation regions, and evacuation routes may be represented using graph-based or rule-linked structural representations. Additionally or alternatively, Constraint relationships may be represented using machine-readable parametric relationships between structural elements and spatial regions.

Intended use input 124 may store or receive data associated with planned functionality of a building or portion of a building. Example intended use information may include residential occupancy requirements, occupancy requirements, mixed-use occupancy requirements, rentable-area targets, circulation requirements, service-area requirements, and floor-use requirements associated with one or more portions of a structure. In some embodiments, intended use information may influence generation of candidate floor plans, candidate building core arrangements, circulation pathways, utility-routing regions, and usable floor-area distributions.

User preference input 126 may receive preference information associated with design-selection criteria or design priorities. Example preference information may include target construction cost ranges, sustainability preferences, rentable-area preferences, desired floor layouts, construction-speed preferences, architectural-style preferences, and material preferences. In some embodiments, preference data may influence weighting of candidate building configurations during ranking and selection operations. Preference information may additionally influence preservation of structurally distinct candidate building configurations during iterative refinement processing.

The system may further include one or more databases 128 storing machine-readable building data accessible by one or more processors associated with the disclosed system. The databases 128 may include local databases, cloud-based databases, remote servers, online databases, and/or distributed data-storage systems. Stored data may include zoning information, fire safety rules, accessibility requirements, historical building designs, environmental information, structural engineering rules, construction-material information, occupancy data, mapping data, and/or architectural templates. In some embodiments, the disclosed system may retrieve updated regulatory or environmental information from external network-accessible data sources during generation or evaluation of candidate building configurations.

Core generation engine 130 may generate multiple candidate building core configurations corresponding to different structural and spatial arrangements of a building. Example candidate core configurations may include centralized core arrangements, decentralized core arrangements, peripheral core arrangements, service core arrangements, multi-core configurations, prefabricated core arrangements, cast-on-site core configurations, steel-frame core configurations, and hybrid core configurations. Each generated building core configuration may define corresponding circulation pathways, utility-routing regions, evacuation routes, support structures, elevator shafts, stairwell locations, and usable floor areas. In some embodiments, a candidate building core configuration is represented as a multi-attribute data structure comprising: (i) an integer representing core count; (ii) a coordinate vector $(x, y)$ for the core centroid; (iii) a set of geometric parameters defining the stair/elevator shaft enclosure; and (iv) a stiffness coefficient representing the structural lateral resistance of the core.

In some embodiments, generation of multiple candidate building core configurations may facilitate computational exploration of structurally distinct building arrangements for a common building site or occupancy requirement.

Structural generation engine 132 may generate candidate structural building configurations corresponding to generated building core configurations. In some embodiments, the structural generation engine 132 may generate structural framework arrangements, support structure placement, structural geometries, floor heights, building geometries, foundation layouts, and structural grid spacing associated with each candidate building core configuration. The structural generation engine 132 may additionally generate multiple structural variations corresponding to a single building core arrangement. Example variations may include different support-column layouts, structural frame geometries, floor-to-floor spacing configurations, and circulation arrangements.

In some embodiments, the floor plan generation engine 134 may generate floor plans derived from corresponding structural geometries and spatial configurations associated with generated candidate structural building configurations. The generated floor plans may define positional relationships between structural elements, support structures, circulation pathways, evacuation routes, utility-routing regions, rentable areas, service areas, and occupancy regions. Floor plans generated by the floor plan generation engine 134 may therefore correspond directly to evaluated structural building configurations rather than independently generated conceptual layouts.

Constraint evaluation engine 136 may evaluate candidate structural building configurations according to one or more categories of building constraints. In some embodiments, evaluation processing may include fire safety evaluation, evacuation-route analysis, accessibility analysis, zoning analysis, structural-feasibility analysis, wind-load analysis, seismic analysis, drainage analysis, and occupancy analysis. The constraint evaluation engine 136 may perform coordinated evaluation of multiple interacting constraints affecting candidate building core configurations and corresponding structural arrangements. For example, modification of a building core arrangement may affect evacuation-route compliance, circulation geometry, accessibility compliance, structural span limitations, and rentable-area distribution simultaneously. In some embodiments, the system may computationally evaluate seismic-force distribution associated with different building core arrangements. In some embodiments, modification of building core placement may alter evacuation-route geometry, structural load distribution, and rentable-area allocation simultaneously. The systems may computationally evaluate tradeoffs between evacuation-route compliance, structural span limitations, and usable floor-area distribution associated with alternative candidate building core configurations. In some embodiments, the system will efficiently evaluate linked parameters, for example, elevator-core placement as it relates to rentable area, seismic loads as it affects support-column spacing, corridor geometry affecting evacuation compliance, drainage affecting foundation geometry and/or wind-load constraints affecting core placement.

Candidate filter 138 may eliminate candidate structural building configurations violating one or more building constraints. In some embodiments, candidate building configurations failing fire safety evaluation, structural-feasibility analysis, evacuation-route analysis, zoning analysis, or accessibility evaluation may be rejected prior to additional floor-plan generation or refinement processing. The disclosed filtering operations may therefore reduce computational processing associated with infeasible structural building configurations and improve computational exploration of candidate structural design spaces containing numerous alternative building core arrangements.

Ranking and selection module 140 may rank surviving candidate building configurations according to one or more evaluation metrics for example as delineated above. In some embodiments, the ranking and selection module 140 may preserve multiple structurally distinct candidate building configurations rather than selecting only a single highest-ranked configuration. This may facilitate additional iterative refinement of multiple alternative structural design strategies.

Iterative refinement module 142 may iteratively modify structural parameters associated with candidate building configurations and reevaluate resulting candidate structural building configurations. Example modified parameters may include structural grid spacing, floor height, support structure placement, circulation pathways, structural framework geometry, building geometry, floor-plan geometry, and/or building core placement. In some embodiments, the iterative refinement module 142 may communicate with the core generation engine 130, the structural generation engine 132, the floor plan generation engine 134, and the constraint evaluation engine 136 to facilitate repeated cycles of generation, evaluation, elimination, ranking, and refinement.

The disclosed iterative processing architecture may facilitate computational exploration of candidate building configurations that are impractical to evaluate mentally or manually due to the number of interacting variables and technical constraints. In some embodiments, preservation and refinement of multiple structurally distinct building core configurations may improve computerized generation of technically feasible building structures satisfying structural, regulatory, spatial, and occupancy requirements simultaneously. In some embodiments, candidate structural building configurations may be evaluated concurrently using distributed or parallel computational processing. Multiple candidate building core configurations may be processed simultaneously across distributed computing resources.

Building design output 144 may output one or more selected candidate building configurations corresponding to surviving structural building configurations. Example output information may include floor plans, structural geometries, building core configurations, evacuation layouts, circulation layouts, support structure arrangements, anticipated floor use, projected cost information, anticipated rent revenue, compliance information, and/or structural analysis information. In some embodiments, the disclosed system may therefore facilitate computerized generation of structurally feasible and regulation-compliant building designs through coordinated computational evaluation of multiple candidate building core configurations and corresponding structural building configurations.

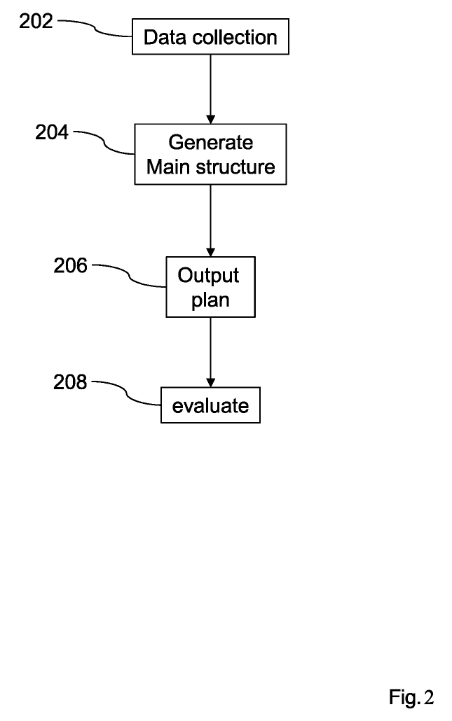

FIG. 2 is a flow chart illustration of a computer assisted method of designing building in accordance with an embodiment of the current invention.

In some embodiments, a computerized system will collect 202 and/or store data for use designing the building for example, to determine constraints on the building and/or evaluate 208 whether the building is compliant with the constraints. For example, the system may collect 202 data from the user as to the intended use of the building and/or particular design preferences (for example, a designer may add constraints on the shape of the building e.g., that it should include an acute angle and/or particular features e.g., there should be an arched support visible etc.). For example, the user may specify that the building may be used for residential, industrial or commercial purposes. Alternatively or additionally, the system may consider various use scenarios and compare the costs and/or benefits of each possible use. Use may affect anticipated load-bearing requirements, local building codes, and environmental conditions. In some embodiments, the purpose of the building significantly influences the design decisions regarding the size and layout of the main support elements. Anticipated loads, both static and dynamic, including the weight of the structure itself, occupant loads, furniture, and equipment, are crucial considerations.

In some embodiments, building constraints may relate to specific spatial needs and layout requirements implicit in different uses. The constraints may influence the floor plans, room sizes, and overall building footprint. Loads imposed by the intended use, whether heavy machinery in factories or large crowds in event spaces, may constrain the structural design and material choices. Accessibility and circulation may constrain designs to enable efficient movement for users, including provisions for disability access, optimized traffic flow, and well-planned emergency evacuation routes. Preferred lighting and/or acoustics may be associated with intended use. Intended use may create constraints relating to environmental regulations and sustainability standards. Budget and construction timeline may be influenced by the intended use, impacting resource allocation, material selection, and/or construction methods, and or creating constraints on the speed of the project.

Buildings may include constraints shaped by their specific functions. For example, office buildings, may be designed for open workspaces and/or potential conference centers. These buildings may be constrained to include flexible floor plans and/or robust technological infrastructure. For example, shopping malls, housing retail stores, restaurants, and/or entertainment venues, may be constrained for high accessibility, ample open space, and/or integrated amenities. For example, convention centers designed for large-scale events, may be constrained to include flexible and adaptable spaces and/or convenient infrastructure for conferences and trade shows. For example, hotels, providing temporary lodging, may include constraints related to room configurations, communal areas for dining and/or gathering, and/or provision of adequate parking facilities. For example, residential buildings, such as apartment complexes, senior living facilities, and/or student housing, may be constrained to link efficient space utilization, diverse unit types, and considerations for communal amenities, accessibility, and security. For example, public and institutional structures like hospitals, schools, universities, museums, and transportation hubs may include constraints, including specialized functionality, hygiene and safety protocols, flexible spaces, controlled environments, efficient circulation, diverse services, and/or security measures.

On some embodiments, the system may collect data on building codes and regulations, for example, the minimum standards and safety requirements, influencing decisions on material selection, construction methods, and overall structural design. Regulatory requirements and compliance with building codes shape decisions on space allocation, ensuring safety, accessibility, and adherence to legal standards.

In some embodiments, the system gathers environmental information. For example, information may be downloaded from a network about wind distribution and/or the loads that it may cause on the building. The information may be checked by human and/or automatic routines. Optionally, data on geology including soil and/or rock characteristics, seismic activity and/or groundwater are also downloaded from the network. Optionally, the system will evaluation the data. Optionally, the system may analyze where improved data would potentially improve cost or benefits. For example, where data is too sparce and/or uncertainty is high exploratory measurements may be ordered and/or further data may be sought. For example, drilling and/or sampling may be performed. For example, the data may be used to plan foundation and/or waterproofing and/or drainage. Plumbing, wiring, ventilation constraints may affect locations of walls rise and floors.

In some embodiments, data may be collected for other factors like the potential for future expansions, technological advancements. For example, this data may be used to evaluation sustainability constraints that impact the design decisions. For example, design may account for flexibility and adaptability in the main support structure. In essence, a comprehensive understanding of these constraints facilitates that the design decisions align with the more specific constraints (e.g., safety standards, and long-term functionality of the large building's main support structure). Technological preferences, such as the integration of IT infrastructure and communication systems, may impact various aspects of planning.

In some embodiments, the system may collect information on expected costs and prices for example, of building materials, labor, transportation, fuel, building staffing, over time. Budget constraints like material choice and construction time influence how space is used.

In some embodiments, the system will use the collected information and generate 204 multiple options of possible designs for the main support of the building.

In some embodiment, the design for the main structure will include one or more options for the building core. Various types of building cores may be generated 204 and/or evaluated 208. For example, one or more designs for a concrete core may be generated 204. Optionally, a concrete core may utilize reinforced concrete for constructing core walls, columns, and/or floors. Concrete cores may be preferred when the building constraints include fire resistance, soundproofing, and/or structural stability. For example, concrete cores may be included in designs for high-rise buildings, hospitals, and structures with high occupancy. Optionally, one or more steel cores will be generated, for example, steel cores may be preferred when there are significant constraints on weight, cost and speed of construction. For example, steel cores may include steel beams and columns. For example, steel core designs may be supplied for buildings with expansive open spaces and flexible layouts like office buildings or shopping malls, steel cores, though efficient, may have lower fire resistance, necessitating additional soundproofing measures. Alternatively or additionally, hybrid cores may combine elements of both concrete and steel, for example strike a balance between cost, speed, and performance. This type of core may be preferred in mid-rise buildings where a blend of structural strength and flexibility is desired. In some embodiments, the core may utilize other materials (e.g., fiber-reinforced polymers (FRPs)). This approach offers several advantages, including a high strength-to-weight ratio, corrosion resistance, and improved seismic performance. However, the technology is still relatively new and may incur higher upfront costs. In some embodiments, for example, when there are significant constraints that favor steel and/or hybrid and/or concrete cores, designs of one or more of each relevant type of core may be generated 204 and/or evaluated 208. Some embodiments may include a centralized core and/or a decentralized core and/or multiple cores.

In some embodiments, the system will generate 204 one or more plans for essential building services such as plumbing, electrical, and ventilation systems. For example, these services may be integrated into the main core or located separately, providing flexibility based on the building's design and space constraints.

In some embodiments a system may generate 204 multiple options for the shape of a building. For example, designs may be rectangular and/or include obtuse and/or acute angles and/or curves. For example, the building may be shaped for aesthetic reasons and/or better use of space and/or other factors. Optionally, multiple options of building shape with be generated 204 and/or evaluated 208.

In some embodiments, for example design for a building foundation and/or core, the system will generate 204 one or more designs for structural elements such as beams, columns, slabs, bracing systems, arches and/or shells.

In some embodiments, the system includes design options for horizontal structural elements. Optionally, horizontal elements may distribute loads and/or support vertical elements such as columns and walls. For example, the horizontal elements may include beams, arches, trusses, and/or shells. A design constraint for horizontal elements may include their ability to resist bending forces. The size, shape, and material of the element may be chosen to facilitate withstanding the anticipated loads without excessive deflection or failure. Additionally, the span length, support conditions, and load distribution may influence design. For example, beams may include various cross-sectional shapes, (e.g., I-shaped, or others).

Various optional geometries of beams may be included in a design. For example, I-beams may enhance stiffness and/or improve the beam's ability to resist buckling. I-beams find extensive use in various structural applications, particularly where higher load-carrying capacity and enhanced stability are essential. W-shaped beams represent another evolution in support elements, offering characteristics similar to I-beams but with wider flanges. This design modification provides even greater bending strength and load-carrying capacity, making W-beams suitable for heavy-duty applications. Bridges and long-span roofs, which demand robust support systems, often incorporate W-beams to facilitate structural reliability under substantial loads. Optionally, box beams may include a hollow rectangular section, these beams may offer improved torsional rigidity and the ability to resist bending in multiple directions. This makes them particularly suitable for architectural applications where both functionality and visual appeal are crucial. Circular beams may provide bending and shear resistance in all directions. For example, they may be suitable for situations where structural loads are distributed in a multidirectional manner. Circular beams may occasionally be employed for decorative purposes. In some embodiments, T-shaped beams offer efficiency in one-way bending, making them well-suited for applications like floor joists and other horizontal members. With a flange on one side of the web, T-beams provide structural support while optimizing material usage.

In some embodiments, the system will include one or more design options for vertical elements. For example, columns are vertical structural elements that may provide support to horizontal elements and/or transfer loads to the building foundation. In some embodiments, a column is constrained to resist axial loads and, in some cases, lateral loads such as those from wind or seismic forces. Design options may include the height, cross-sectional dimensions, and material properties (e.g., the properties may be selected to prevent buckling and/or facilitate stability). Aesthetic considerations may play a role in column design, as they contribute to the overall visual appeal of the building.

In some embodiments a design and/or multiple designs will include various geometries for vertical elements. For example, square columns, characterized by simplicity and efficiency in supporting compression loads, may be used. In some embodiments a design may include rectangular columns. For example, the column may be adapted with different side lengths for load requirements that vary between directions, for example, in cases where there are unbalanced lateral loads. Circular columns are resistance to lateral loads, for example wind, become integral in buildings with large open spaces and/or for aesthetic considerations. Non-circular columns may be preferred by the column is to be attached to straight elements. Composite sections may be designed by joining two smaller elements, elevating structural performance by offering greater bending and torsional stiffness, e.g., for scenarios where columns must withstand both axial and lateral loads. In some embodiments, the composite columns may be formed of concrete-encased steel columns. Such columns may combine the strength of steel with the fire resistance and ductility of concrete.

In some embodiments, a plan may include one or more options for core type in for example, depending on strategic constraints based on construction requirements, design flexibility, speed, and/or material preferences. For example, a core may include cast-in-place concrete. For example, the cast in place concrete may be poured directly on-site, offer monolithic strength and flexibility for intricate architectural variations. The cast in place core may be contraindicated when the is a strict constraint on construction times. In some embodiments, a precast concrete core may be planned. For example, the precast core may utilize prefabricated panels assembled on-site, plans that prioritize faster construction but with limited design flexibility precast cores may be preferred. In some embodiments, a plan may include a steel frame core. For example, the steel frame core may employ steel beams and columns, providing both strength and design versatility, with infill walls made of various materials for aesthetic considerations. Alternatively or additionally, building plans may include an option for a mixed or hybrid core. For example, the core may have concrete walls with steel framing.

In some embodiments, the system will include one or more design options for two-dimensional structural elements. For example, two-dimensional elements may include planar slabs. Optionally, a slab may form a floor and/or a ceiling of a building. Design constraints for slabs include their ability to support dead loads (permanent loads like the structure's weight) and live loads (variable loads like occupants and furniture). The thickness of the slab, reinforcement detailing, and material selection are aspects of slab design that may be generated 204 and/or output by the system. The system may supply one or more options for slabs including different types of slabs, (e.g., flat slabs, waffle slabs, or ribbed slabs).

In some embodiments, the system will include one or more design options for a foundation. For example, the foundation may transfer building loads to the ground. Design constraints for foundations may include ensuring stability against settlement, preventing differential settlement, and resisting uplift forces. The type of foundation, whether shallow (such as spread footings) or deep (such as piles or caissons), may depend on constraints such as soil conditions and building loads, safety factors, building loading etc.

In some embodiments, the system will include one or more design options for a bracing system. For example, a bracing system may include elements designed to provide lateral stability to a building, especially against forces like wind or earthquakes. Constraints for bracing systems involve the locations for braces to resist lateral loads effectively. The design constraints include both the strength and stiffness of the bracing elements. The functional requirements of the bracing system may be balanced with its impact on the building's aesthetics, as visible bracing elements can influence the overall design and interior space planning.

For each main structure generated 204 the system may output 206 one or more plans for the building (e.g., for plans, architectural and/or esthetic aspects of the building, construction plans, management plans, plans for rental and/or selling of space).

Optionally, the system may evaluate 208 each plan. For example, evaluation 208 may include predicted risk and/or costs and benefits of each plan. The evaluation 208 may be presented to a designer for final approval and/or further refinement.

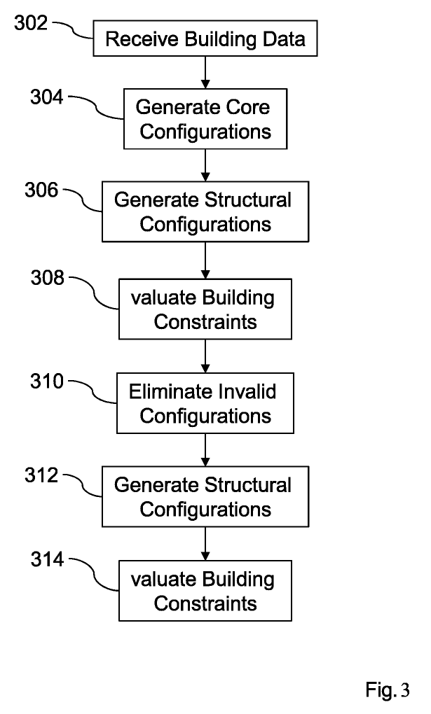

FIG. 3 illustrates an example computational workflow 300 associated with generation of structurally feasible and regulation-compliant building designs. In some embodiments, the workflow 300 may include receiving building information, generating candidate building core configurations, evaluating candidate structural building configurations, filtering candidate building configurations, generating floor plans, and outputting candidate building designs. The disclosed workflow may facilitate computational processing of interacting structural, spatial, environmental, and regulatory conditions associated with building design generation.

Receiving building data 302 may include receiving or accessing machine-readable building information associated with a candidate building project. In some embodiments, the received building information may include intended building use data, occupancy information, zoning restrictions, fire safety requirements, accessibility requirements, site geometry information, environmental conditions, structural limitations, and/or spatial constraints. Alternatively or additionally, receiving building data 302 may include retrieving information from one or more databases, remote servers, mapping systems, or online data sources.

In some embodiments, receiving building data 302 may include receiving geographic information associated with a building site. Example information may include topographical information, property boundaries, adjacent structures, road-access locations, utility-access locations, setback requirements, allowable building envelopes, and/or environmental conditions. The received data may facilitate generation of candidate structural building configurations corresponding to a selected building site or development region.

Generating core configurations 304 may include generating multiple candidate building core configurations corresponding to different structural and spatial arrangements of a building. Example building core configurations may include centralized core configurations, decentralized core configurations, edge-positioned core configurations, service core configurations, prefabricated core configurations, cast-on-site core configurations, steel-frame core configurations, hybrid core configurations, and/or multiple-core arrangements. Different building core configurations may correspond to different circulation pathways, utility-routing regions, support structure arrangements, evacuation routes, and usable floor areas.

In some embodiments, generating core configurations 304 may include generating multiple candidate structural building configurations corresponding to a single candidate building core configuration. Candidate structural building configurations may include structural geometries, structural framework arrangements, support structure placement, floor heights, circulation layouts, and/or building geometries. Alternatively or additionally, multiple candidate building core configurations may correspond to a common intended building use or occupancy requirement.

Generating core configurations 304 may further include iterative refinement of candidate structural building configurations. In some embodiments, one or more structural parameters associated with generated candidate building configurations may be modified and reevaluated according to one or more building constraints. Example modified parameters may include structural grid spacing, floor height, support structure placement, circulation pathways, structural framework geometry, building geometry, and/or floor-plan geometry.

Evaluating building constraints 308 may include evaluating candidate structural building configurations according to one or more categories of building constraints. Example building constraints may include structural constraints, regulatory constraints, environmental constraints, spatial constraints, fire safety requirements, zoning restrictions, seismic requirements, wind-load limitations, accessibility requirements, drainage constraints, foundation constraints, and/or occupancy requirements. In some embodiments, multiple interacting constraints may be evaluated concurrently for corresponding candidate building core configurations.

In some embodiments, evaluating building constraints 308 may include evaluating evacuation-route compliance associated with corresponding candidate building core configurations. For example, a selected core arrangement may influence maximum travel distance to exits, corridor dimensions, stairwell placement, and circulation geometry. Alternatively or additionally, evaluation of accessibility compliance may affect corridor spacing, floor-plan geometry, and placement of support structures or circulation regions.

Evaluating building constraints 308 may additionally include computational analysis of structural feasibility associated with generated candidate structural building configurations. Example structural evaluations may include analysis of structural span limitations, support structure distribution, building-height limitations, structural framework arrangements, and/or environmental loading conditions. In some embodiments, structural feasibility evaluation may influence generation of additional candidate building core configurations or structural geometries.

Eliminating invalid configurations 310 may include filtering or rejecting candidate structural building configurations violating one or more building constraints. In some embodiments, candidate building configurations failing structural-feasibility analysis, fire safety evaluation, evacuation-route analysis, accessibility evaluation, or zoning analysis may be excluded from subsequent processing operations. Filtering operations associated with eliminating invalid configurations 310 may reduce processing associated with infeasible candidate structural building configurations. Constraint-based elimination routines may reduce generation of structurally infeasible floor-plan geometries.

In some embodiments, eliminating invalid configurations 310 may occur prior to additional floor-plan generation or structural refinement operations. Candidate structural building configurations satisfying selected building constraints may proceed to additional processing stages. Alternatively or additionally, structurally distinct candidate building configurations may be preserved for further evaluation or refinement.

Generating floor plans 312 may include generating floor-plan geometries derived from corresponding structural geometries and spatial configurations associated with surviving candidate structural building configurations. In some embodiments, generated floor plans may define positional relationships between circulation pathways, support structures, usable floor areas, structural elements, utility-routing regions, evacuation routes, and/or occupancy regions associated with a corresponding building core configuration.

Generating floor plans 312 may additionally include automatic generation of floor plans corresponding to different candidate building core configurations. For example, different building core arrangements may correspond to different corridor layouts, rentable-area distributions, service regions, structural framework geometries, and circulation pathways. The disclosed workflow may therefore facilitate coordinated generation of floor plans and structural building configurations corresponding to multiple alternative building core arrangements.

Outputting building designs 314 may include outputting one or more candidate building configurations corresponding to surviving structural building configurations. Example output information may include structural geometries, floor plans, circulation layouts, building core configurations, support structure arrangements, evacuation layouts, compliance information, and/or occupancy information. In some embodiments, outputting building designs 314 may include generating visual representations, digital models, construction drawings, or machine-readable building representations corresponding to selected candidate building configurations.

Optionally, outputting building designs 314 may include ranking candidate building configurations according to one or more evaluation metrics. For example, evaluation metrics as enumerated above. In some embodiments, ranking operations may preserve multiple structurally distinct candidate building configurations for additional refinement, comparison, or architectural evaluation.

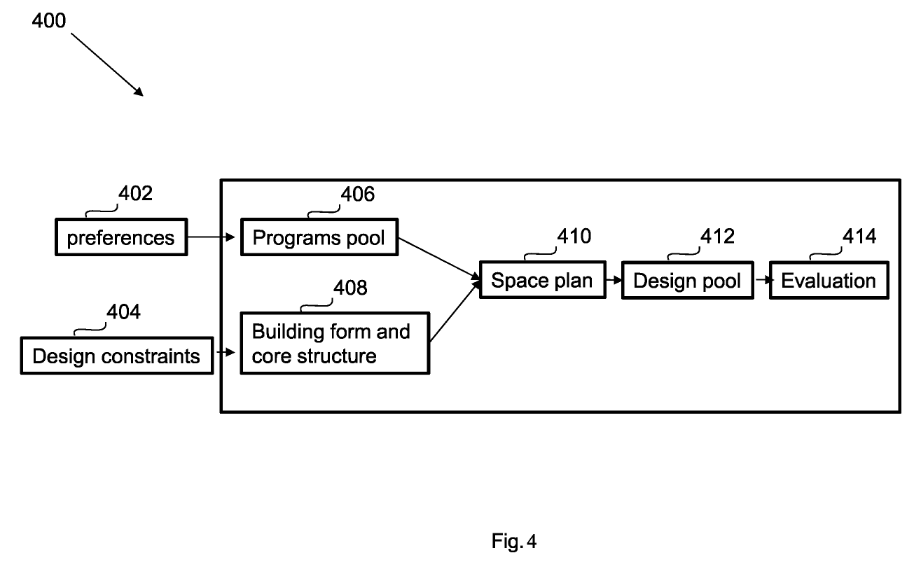

FIG. 4 is a flow chart illustrating a method of an embodiment of the current invention. For example, in method 400, various preferences 402 and/or desired uses and/or needs are incorporated into the program. Additionally, or alternatively, building design constraints 404 are incorporated into the program. The preferences 402 and/or building design constraints 404 may be pre-programmed into the program (and then selected by the user) and/or may be manually inputted by the user. Optionally, data on stylistic preferences, statutory requirements, utilities, location, desired profitability, etc. may be input to a programs pool 406. Optionally, a preselected building form and/or core structure 408 may be input to the program. Optionally, the program may design one or more building forms and/or core structures. Optionally, a user may select several building forms and/or core structures, optionally generated by the program, from which to proceed to generate a space plan 210 and/or a design pool 212 and/or provide a cost-benefit evaluation 214.

Optionally, surrounding and/or local architecture may be incorporated in evaluating user preferences and/or design constraints. For example, a user may input locations of surrounding buildings and/or parking, and/or utilities, and/or public transportation and/or local weather conditions (such as, high snowfall, high temperatures, monsoons, etc.), and/or earthquake protection, etc. Optionally, some embodiments may incorporate data from mapping programs. Optionally, some embodiments may incorporate data from images of the surrounding area. For example, the program may analyze the appearance of surrounding architecture and, optionally, may incorporate it into the building plan.

In some embodiments, building design constraints may include, for example, plot dimensions and/or other plot details. For example, details about the ground quality, and/or soil analysis, and/or what can be built into it (e.g., basement) and/or what and/or where can be built onto it. The building restrictions may include statutory details (such as, building laws and/or restrictions and/or preferences). Optionally, a user may be able to select a country and/or town and/or city in which construction is planned, and the program may provide the preferences and restrictions of the selected location. Optionally, there may be updates that may be downloaded by the user that include new locations and/or updated local laws.

An embodiment may incorporate various tenant and/or user preferences. Optionally, user preferences may include desired space needs and/or uses and/or dimensions and/or design features and/or amenities, etc.

In some embodiments, program may test possible building layouts by generating various building assignments for potential tenant preferences which are either generated (for example, randomly and/or based on external data [for example, data of nearby buildings]) and/or sampled from a database. For example, such an embodiment may be used when the building is in a conceptual stage, before specific preferences are available and/or when there is limited data on potential tenants. Optionally, a user may be able to select preferred user requirements.

In some embodiments, the program may generate various options for each input. For example, a user may be able to input a weight for the importance of each factor. For example, the weighting may be by a number system such that a factor that is crucial may be weighted as number 10 and/or something unimportant may be weighted as l.

According to some embodiments, building constraints may include heights of building, and/or floors, and/or rooms, and/or may include floor geometry and/or utility features (e.g., water, and/or electricity, and/or gas, and/or heating and/or cooling preferences), parking, strength preferences (e.g., earthquake resistance), foundation preferences.

An embodiment may include pre-programmed constraints for various types of uses of the building. For example, there may be a setting to design an apartment building and/or an office building and/or a store and/or a supermarket and/or other. Optionally a user may be able to download additional standard types of buildings and/or building usage parameters and/or constraints and/or a program may output building constraints based on user plans and/or inputs. Optionally, a user may input parts of the building that have certain predetermined constraints and/or usages and/or other parts of the building which may have other predetermined constraints. For example, one floor may have a certain use and/or another floor may have another use.

According to some embodiments, tenant preferences may include various settings for building appearance and/or aesthetics. Optionally tenant constraints may include various settings for building materials and/or details, for example, types of windows and/or doors and/or wall and/or building materials, etc. Optionally, such data may be upgraded as technology, and/or building methods, and/or building materials and/or tenant preferences, and/or building statutes evolve.

An embodiment may include user input on various optional and/or essential additions to the building. For example, a user may input as a building constraint, and/or preference, an elevator, and/or a swimming pool, and/or garage, and/or parking lot, and/or an atrium, and/or solar panels, etc.

According to some embodiments, once tenant constraints and/or preferences and/or building restrictions are input and/or selected, the program may generate various building forms and/or core structure, and/or floor plans. Optionally, the program may generate multiple building core and/or frame and/or floor plans. According to some embodiments, the program will then analyze and/or evaluate each building plan, and/or part thereof. Optionally, a user may select how many optional building plans are shown. According to some embodiments, the program may then present and/or report to the user the building plans according to pre-selected preferences, e.g., plans with potential profit margins above a preselected threshold value, etc. Optionally, the program may report to the user various advantages and/or disadvantages of each building plan. Optionally, the program may report to the user long-term profit predictions and/or short-term profit predictions. Optionally, the program may facilitate analysis of the various advantages and/or disadvantages of each section of each building plan. Optionally, the program may facilitate analysis of the long-term profit predictions and/or short-term profit predictions of each section of each building plan. Optionally, such analysis may facilitate evaluation of each section of the building plan, as well as the overall building plan.

According to some embodiments, the program may be used by a user to renovate a preexisting building, and/or floor, and/or part of a building.

According to some embodiments, the program may be connected to a database of contractors. Optionally, the database may include a user rating system. Optionally, a contractor database may assist the user to assess costs. Optionally, a contractor database may assist the user to select a contractor who specializes in and/or has a good review for the desired building requirements. Optionally, a contractor database may include an availability timetable of the contractors, e.g., to assist the user in selecting a contractor for work to be performed by a deadline.

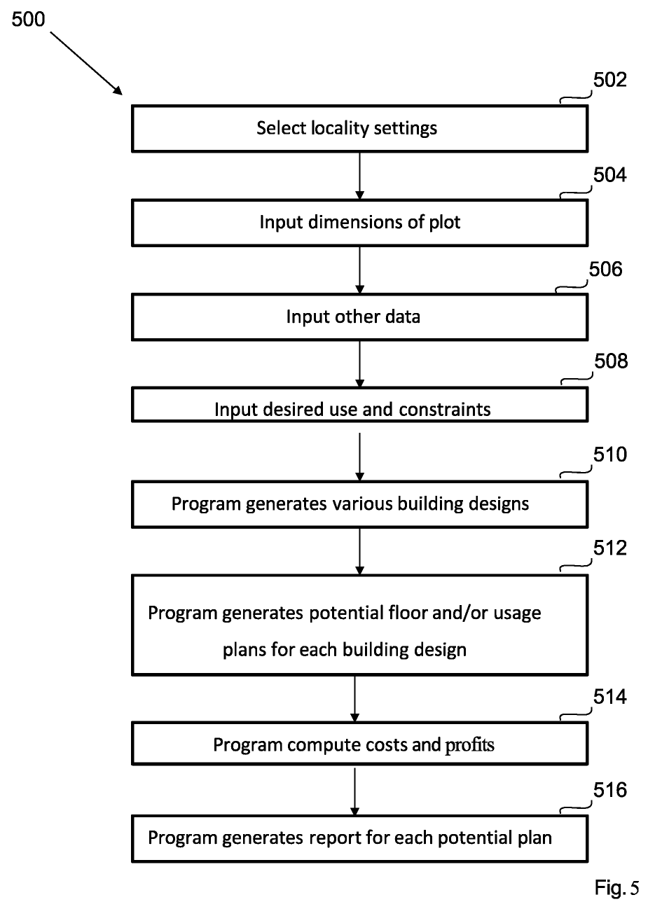

FIG. 5 is a flow chart illustrating a method of optimizing design of a building according to an embodiment of the invention. For example, in method 500, the algorithm may include an input interface that requests a user to gather information, and/or accesses the information automatically (for example from on-line sources and/or databases. Information which may be input and/or accessed may include locality settings 502, such as local ordinances, map navigation data relating to traffic, public transportation, local services, and/or location of building resources, geographical databases (for example for information about bedrock depth and strength, groundwater depth at various times of year etc.), climate databases (for example to determine needs for lighting, heating, cooling, expected wind speeds, drainage needs), commercial databases (for example to compute the availability of materials, power, construction etc.). The dimensions 504 of the plot may be input. Optionally additional local information 506 may be collected (either from the user, automatically, or elsewise). For example, architectural issues (for example the surrounding architecture and matching issues), surroundings (are there tall buildings around, what is the potential value of the view, what effect the architecture will have on wind, sun exposure etc.), access limitations, etc. Optionally, limitations and/or plans for use of the space 508 may be input (are there already committed tenants? Selected uses (such as, apartments, offices, supermarkets, etc.)). The algorithm optionally generates multiple building designs 510 (for example, designs for the shell and/or core of the building). The algorithm optionally generates floor plans and/or usage plans 512. The algorithm optionally computes 514 the estimated cost and profit of the various designed building spaces. Optionally, the results are organized and presented to the user (e.g., in a report) 516 to select the preferred combination of long and/or short-term costs and/or profits and/or risks.

In some embodiments, the data may be used for constraints on the problem and/or variable bounds and/or to develop an objective function. Optionally, the alternative design choices and/or report details may be guided, for example using optimization routines (for example, linear programming, non-linear programming, stochastic programming, dynamic programming, combinatorial optimization, infinite-dimensional optimization, hill climbing, simulated annealing, genetic algorithms, ant colony optimization) and/or Artificial intelligence (for example, cybernetic approaches symbolic approaches cognitive simulation, logic-based methods, knowledge based, pattern recognition, neural networks, integrated methods, deep learning etc.). Genetic algorithms may facilitate exploration of non-convex structural design spaces containing numerous candidate building core configurations. Simulated annealing routines may facilitate refinement of circulation layouts and structural geometries while reducing convergence to locally optimized structural arrangements. Constraint-propagation routines may facilitate elimination of infeasible structural building configurations prior to additional floor-plan generation. Combinatorial optimization routines may facilitate evaluation of interacting evacuation-route, circulation, and structural-span constraints associated with alternative building core arrangements.

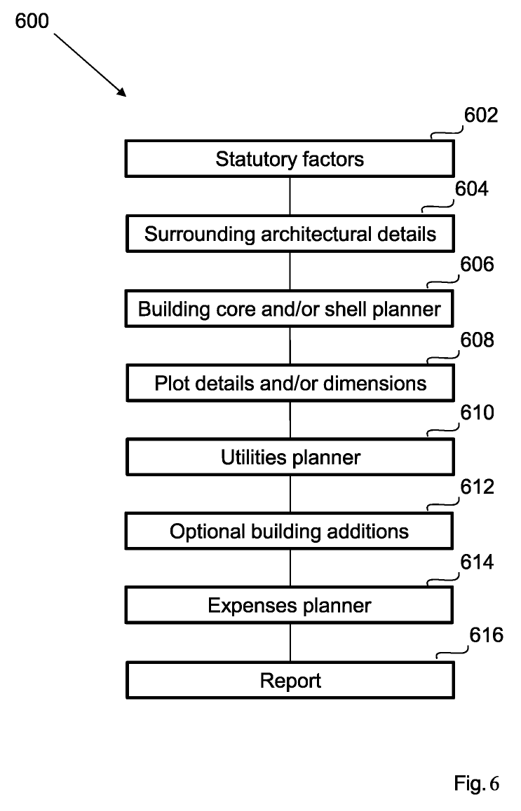

FIG. 6 is a block diagram illustrating various aspects of an embodiment of the invention. The system may include an input interface. Optionally, the interface may facilitate manual and/or automatic data input. In some cases, data may be input in accordance with preset forms and/or formats. Additionally, or alternatively, free input may be supplied. Optionally the system may include modules that develop multiple plans for various options. In some embodiments, various reports may be generated graphically and/or symbolically and/or verbally summarizing the results for each of the possible designs and/or parts thereof and/or for the entire project.

For example, system 600 may include one or more modules for input of standardized data. Optionally, the data may be input manually and/or accessed automatically by the system from one or more databases. Optionally, the data may be entered into and/or selected from a series of menus. Data may include statutory constraints 602, surrounding architectural details 604, weather conditions, transportation, utilities, geographical data, commercial data, building materials, logistical issues, etc. Optionally, system 600 may include one or more data input modules (e.g., 602, 604), building core and/or shell planner module 606, a plot details and/or dimension module 608, a utilities planner module 610 (e.g., plumbing, electricity, gas, internet, etc.), optional modules 612 (e.g., for amenities, specialized usage, etc.), an expenses planner module 614, and/or a reporting module 616.

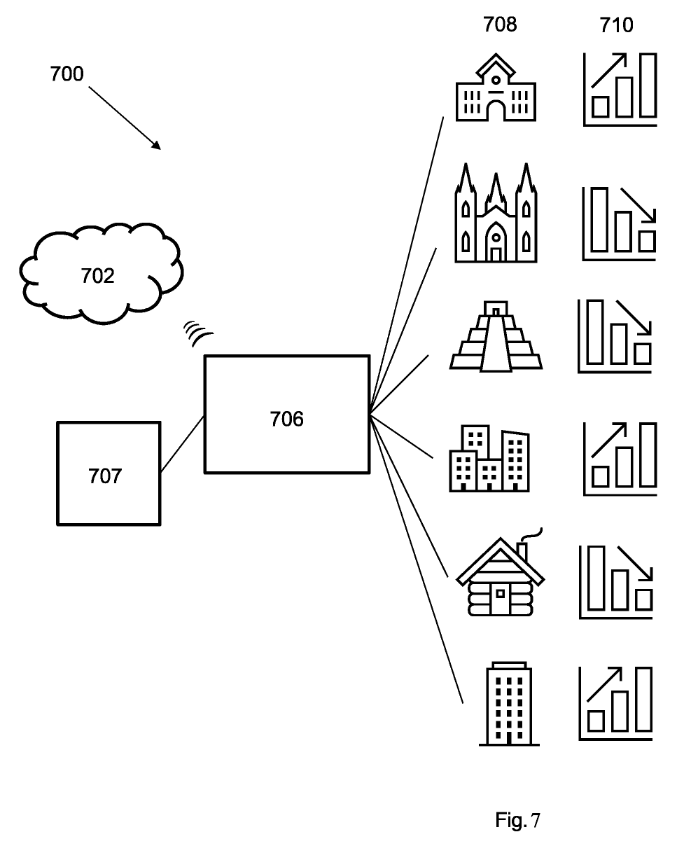

FIG. 7 is a schematic illustration of the system in accordance with some embodiments. For example, in system 700, data may be input manually 704 and/or accessed from various online and/or local databases 702 to a system 706. Optionally, the algorithm may include one or more modules, for example as disclosed herein. System 706 may output multiple possible building designs 708, each with its own cost benefit evaluation 710, and/or a comparison of the various building designs and their cost benefit evaluations.

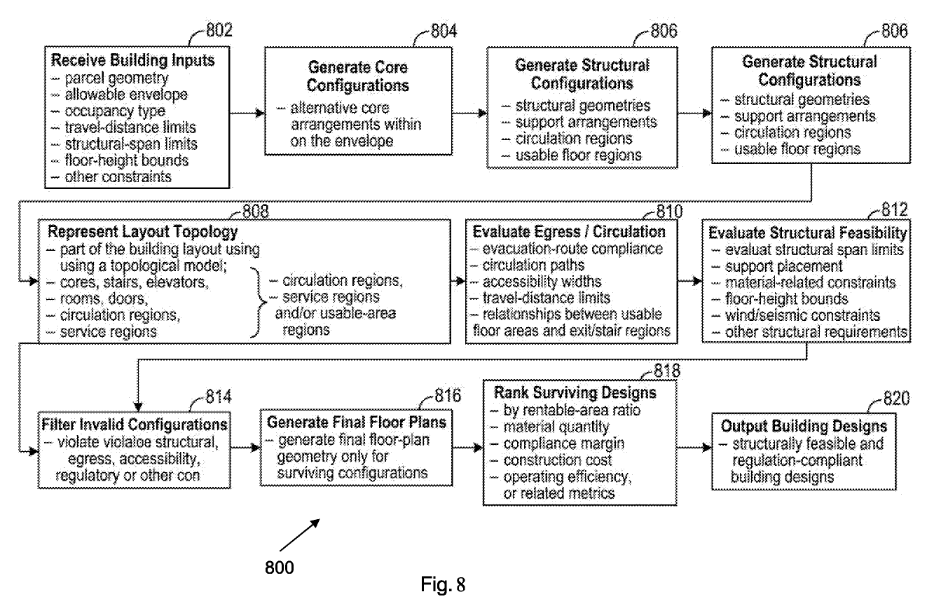

FIG. 8 illustrates a structural configuration evaluation workflow for generating structurally feasible and regulation-compliant building designs in accordance with some embodiments. For example, the structural configuration evaluation workflow 800 for generating structurally feasible and regulation-compliant building designs. The workflow 800 may be performed by one or more processors of the architectural computing system described herein.

The workflow 800 may begin at a receive building inputs operation 802. The receive building inputs operation 802 may receive machine-readable building information including parcel geometry, permitted building-envelope data, intended building-use information, occupancy requirements, and one or more structural, regulatory, environmental, and spatial constraints. Example constraints may include fire-safety requirements, evacuation requirements, accessibility requirements, zoning restrictions, structural limitations, environmental conditions, and combinations thereof.

The workflow 800 may proceed to a generate core configurations operation 804. The generate core configurations operation 804 may generate a plurality of candidate building core configurations corresponding to different structural and spatial arrangements of a building. Example candidate core configurations may include centralized core configurations, decentralized core configurations, edge-positioned core configurations, multiple-core configurations, and other core arrangements. Different candidate core configurations may define corresponding circulation regions, support regions, utility-routing regions, evacuation routes, and usable areas.

The workflow 800 may further include a generate structural configurations operation 806. The generate structural configurations operation 806 may generate one or more candidate structural building configurations corresponding to each candidate building core configuration. The generated structural building configurations may include structural geometries, support structure arrangements, circulation regions, service regions, floor-height arrangements, and spatial relationships associated with corresponding candidate building core configurations.

The workflow 800 may proceed to a represent layout topology operation 808. The represent layout topology operation 808 may generate a machine-readable topological representation associated with one or more candidate structural building configurations. The topological representation may define relationships among building cores, circulation regions, rooms, support structures, service regions, stair regions, elevator regions, occupancy regions, utility-routing regions, and usable areas. Optionally, portions of the representation may utilize graph-based structures to represent selected spatial relationships and circulation relationships.

The workflow 800 may proceed to an evaluate egress and circulation operation 810 and an evaluate structural feasibility operation 812. The evaluate egress and circulation operation 810 may evaluate evacuation-route compliance, accessibility requirements, circulation relationships, travel-distance limitations, and other circulation-related constraints associated with corresponding candidate building core configurations. The evaluate structural feasibility operation 812 may evaluate structural-span limitations, support structure placement, structural stability, foundation conditions, wind-load constraints, seismic constraints, floor-height requirements, and other engineering considerations associated with corresponding candidate structural building configurations.

The workflow 800 may further include a filter invalid configurations operation 814. The filter invalid configurations operation 814 may exclude candidate structural building configurations that violate one or more building constraints. Candidate configurations failing structural-feasibility evaluation, evacuation-route evaluation, accessibility evaluation, zoning evaluation, fire-safety evaluation, or other building-constraint evaluations may be excluded prior to further processing.

The workflow 800 may proceed to a generate final floor plans operation 816. The generate final floor plans operation 816 may generate floor plans derived from structural geometries, spatial configurations, circulation regions, support structures, and corresponding candidate building core configurations associated with surviving candidate structural building configurations. The generated floor plans may therefore correspond to evaluated structural building configurations.

The workflow 800 may further include a rank surviving designs operation 818. The rank surviving designs operation 818 may evaluate surviving candidate building configurations according to one or more evaluation metrics. Example evaluation metrics may include material utilization, construction cost, operating efficiency, rentable-area ratio, compliance margin, spatial efficiency, anticipated revenue and combinations thereof.

The workflow 800 may conclude at an output building designs operation 820. The output building designs operation 820 may output one or more structurally feasible and regulation-compliant building designs corresponding to surviving candidate structural building configurations. Example output information may include floor plans, structural geometries, building core configurations, circulation layouts, evacuation layouts, compliance information, and related building-design information.

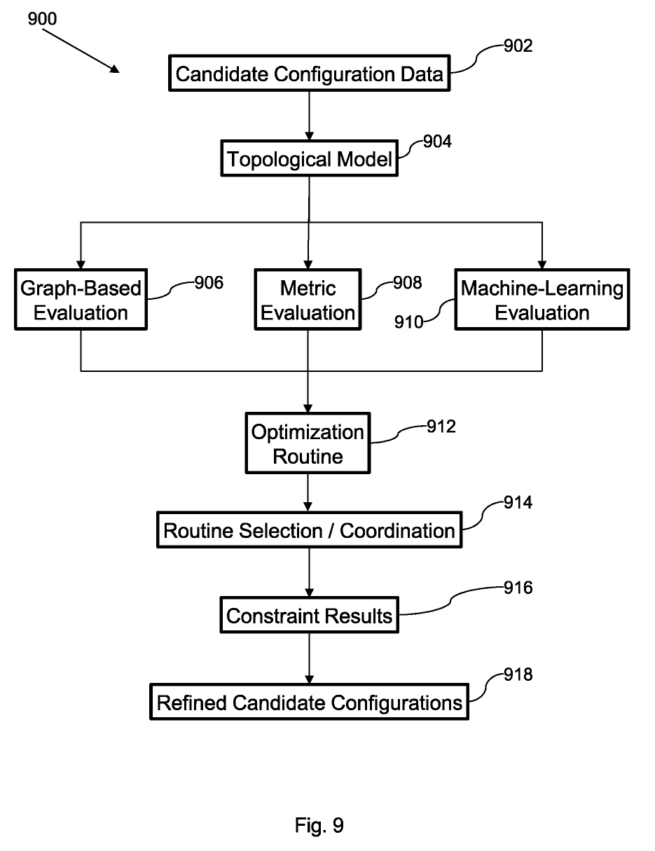

FIG. 9 illustrates a hybrid computational evaluation architecture configured to evaluate and refine candidate building configurations using multiple computational analysis techniques, in accordance with some embodiments. For example, hybrid computational evaluation architecture 900 configured to evaluate and refine candidate building configurations using multiple computational analysis techniques. The architecture 900 may be implemented by one or more processors of the architectural computing system described herein.

The architecture 900 may include candidate configuration data 902. The candidate configuration data 902 may include machine-readable information associated with candidate building core configurations and corresponding candidate structural building configurations. Example information may include structural geometries, circulation regions, support structures, spatial configurations, occupancy information, environmental information, and building constraints.

The architecture 900 may further include a topological model 904. The topological model 904 may represent relationships among building cores, circulation regions, support structures, service regions, stairways, elevators, occupancy regions, utility-routing regions, rooms, and usable areas. In some embodiments, the topological model 904 may facilitate computational analysis of structural and spatial relationships associated with candidate building configurations.

The architecture 900 may include a graph-based evaluation module 906. The graph-based evaluation module 906 may evaluate connectivity relationships associated with circulation pathways, evacuation routes, occupancy regions, accessibility regions, vertical transportation elements, service regions, or combinations thereof. Graph-based representations may be utilized for selected portions of a candidate building configuration.

The architecture 900 may further include a metric evaluation module 908. The metric evaluation module 908 may evaluate quantitative characteristics associated with candidate building configurations. Example characteristics may include circulation efficiency, occupancy efficiency, material utilization, structural-span characteristics, floor-area utilization, accessibility measures, compliance margins, and related evaluation metrics.

The architecture 900 may additionally include a machine-learning evaluation module 910. The machine-learning evaluation module 910 may evaluate candidate building configurations using one or more machine-learning models. The machine-learning evaluation module 910 may generate predicted performance characteristics, classification information, ranking information, or other evaluation outputs associated with candidate building configurations.

The architecture 900 may further include an optimization routine module 912. The optimization routine module 912 may iteratively refine candidate building configurations according to one or more optimization objectives and building constraints. Example optimization routines may include evolutionary algorithms, genetic algorithms, simulated annealing routines, hill-climbing routines, constraint-based optimization routines, and combinations thereof.

The architecture 900 may additionally include a routine coordination module 914. The routine coordination module 914 may coordinate operation of the graph-based evaluation module 906, metric evaluation module 908, machine-learning evaluation module 910, and optimization routine module 912. In some embodiments, the routine coordination module 914 may selectively apply different computational evaluation routines according to characteristics of a candidate building configuration, building constraints, occupancy requirements, site geometry, or available model information.

Outputs generated by the graph-based evaluation module 906, metric evaluation module 908, machine-learning evaluation module 910, and optimization routine module 912 may be supplied to a constraint results module 916. The constraint results module 916 may aggregate evaluation results associated with structural constraints, regulatory constraints, environmental constraints, spatial constraints, evacuation constraints, accessibility requirements, and other building constraints.

The architecture 900 may further include refined candidate configurations 918. The refined candidate configurations 918 may include candidate building configurations that satisfy one or more evaluation criteria. The refined candidate configurations 918 may be stored, ranked, further refined, or supplied to spatial configurations generation systems, visualization systems, reporting systems, building-information-modeling systems, or other downstream systems.

Accordingly, the architecture 900 may facilitate coordinated evaluation of candidate building configurations using multiple computational analysis techniques while supporting generation of structurally feasible and regulation-compliant building designs.

These embodiments are provided by way of example and are in no means intended to be limiting the scope of the invention.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

### GENERAL

It is expected that during the life of a patent maturing from this application many relevant building technologies, artificial intelligence methodologies, computer user interfaces, image capture devices will be developed and the scope of the terms for design elements, analysis routines, user devices is intended to include all such new technologies apriori.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Some embodiments of the invention may be implemented using one or more processors executing stored instructions for generating, evaluating, and refining building configurations subject to structural, regulatory, and environmental constraints. The processors may access local and/or remote data sources including databases containing building codes, environmental data, structural parameters, and architectural information.

In some embodiments, the system performs iterative generation and evaluation of candidate building configurations, including building core arrangements, structural geometries, spatial configurations, and support structures. Candidate configurations that violate selected constraints may be eliminated prior to further evaluation to reduce computational processing.

The disclosed routines may be implemented using optimization processes, rule-based evaluation, artificial intelligence models, constraint-processing routines, geometric analysis routines, or combinations thereof. The routines may execute on local computing systems, distributed computing systems, or cloud-based computing environments.

Computer-readable media may store instructions and/or data used for performing the disclosed methods. The instructions may be executed by general-purpose or specialized computing hardware configured for architectural design generation and structural evaluation.

As used herein the term “about” refers to ± 10%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, l, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may additionally be provided in combination in a single embodiment. Conversely, various features of the invention, which are, for brevity, described in the context of a single embodiment, may additionally be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computer-implemented method for generating building designs satisfying structural and regulatory constraints, the method comprising:
receiving, by one or more processors, machine-readable building data defining an intended building use and a plurality of building constraints including at least one of structural, regulatory, environmental, and spatial constraints;
generating, by the one or more processors, a plurality of candidate building core configurations;
generating, for each candidate building core configuration, one or more candidate structural building configurations comprising structural geometry and spatial configuration data associated with the candidate building core configuration;
generating, by the one or more processors, a topological representation associated with at least one of the candidate structural building configurations, the topological representation defining relationships among building elements of the candidate structural building configuration;
evaluating, by the one or more processors, the candidate structural building configurations according to the plurality of building constraints, including evaluating structural feasibility and evacuation-route compliance associated with corresponding candidate building core configurations;
excluding, by the one or more processors, candidate structural building configurations that violate one or more of the building constraints;
suppressing, by the one or more processors, generation of floor-plan data for candidate structural building configurations excluded based on the evaluating;
generating, by the one or more processors, floor plans derived from structural geometry and spatial configurations of remaining candidate structural building configurations; and
outputting, by the one or more processors, one or more structurally feasible building designs corresponding to the remaining candidate structural building configurations.

2. The method of claim 1, wherein the plurality of candidate building core configurations comprises at least two of centralized core configurations, decentralized core configurations, edge-positioned core configurations, or multiple-core configurations.

3. The method of claim 1, wherein the building elements represented in the topological representation comprise at least one of building cores, circulation regions, support structures, occupancy regions, service regions, stair regions, elevator regions, utility-routing regions, or usable floor areas.

4. The method of claim 1, wherein generating the topological representation comprises generating a graph representation defining connectivity relationships among at least one of circulation regions, evacuation routes, occupancy regions, stair regions, elevator regions, service regions, or usable floor areas.

5. The method of claim 4, wherein evaluating evacuation-route compliance comprises performing a shortest-path evacuation analysis using the graph representation.

6. The method of claim 5, wherein the shortest-path evacuation analysis comprises determining whether a path distance from an occupancy region to an exit-access region satisfies a travel-distance limitation included in the plurality of building constraints.

7. The method of claim 1, wherein evaluating structural feasibility comprises evaluating at least one of structural-span limitations, support structure placement, structural stability, floor-height requirements, foundation conditions, wind-load constraints, seismic constraints, drainage constraints, or zoning restrictions.

8. The method of claim 1, wherein excluding candidate structural building configurations occurs prior to generation of the floor plans.

9. The method of claim 1, wherein suppressing generation of floor-plan data comprises skipping generation of a floor-plan object for a candidate structural building configuration determined to violate at least one of a structural-span limitation or an evacuation-route limitation.

10. The method of claim 1, wherein generating the candidate structural building configurations comprises iteratively modifying one or more structural parameters and reevaluating corresponding candidate structural building configurations.

11. The method of claim 10, wherein the one or more structural parameters comprise at least one of structural grid spacing, floor height, support structure placement, circulation pathways, structural framework geometry, building geometry, or building core placement.

12. The method of claim 1, wherein evaluating the candidate structural building configurations comprises applying one or more optimization routines configured to iteratively refine candidate building core configurations according to the plurality of building constraints.

13. The method of claim 12, wherein the one or more optimization routines comprise at least one of a genetic algorithm, an evolutionary algorithm, a simulated annealing routine, a hill-climbing routine, a combinatorial optimization routine, or a constraint-based optimization routine.

14. The method of claim 1, wherein evaluating the candidate structural building configurations comprises applying a machine-learning model configured to generate predicted performance characteristics associated with candidate building configurations.

15. The method of claim 1, further comprising ranking the remaining candidate structural building configurations according to at least one of rentable-area ratio, material utilization, construction cost, operating efficiency, compliance margin, energy efficiency, anticipated revenue, or projected profitability.

16. An architectural computing system for generating building designs satisfying structural and regulatory constraints, the system comprising:
one or more databases storing machine-readable building data including intended building use data and building constraint data; and
one or more processors configured to:
generate a plurality of candidate building core configurations;
generate, for each candidate building core configuration, one or more candidate structural building configurations comprising structural geometry and spatial configuration data associated with the candidate building core configuration;
generate a topological representation associated with at least one candidate structural building configuration;
generate a graph representation based on at least a portion of the topological representation;
evaluate structural feasibility and evacuation-route compliance associated with corresponding candidate building core configurations, wherein evacuation-route compliance is evaluated using a shortest-path evacuation analysis based on the graph representation;
exclude candidate structural building configurations that violate one or more building constraints;
suppress generation of floor-plan data for candidate structural building configurations excluded based on the evaluation;
generate floor plans for remaining candidate structural building configurations; and
output one or more structurally feasible building designs corresponding to the remaining candidate structural building configurations.

17. The system of claim 16, wherein the topological representation defines relationships among at least one of building cores, circulation regions, support structures, occupancy regions, service regions, stair regions, elevator regions, utility-routing regions, or usable floor areas.

18. The system of claim 16, wherein the graph representation defines connectivity relationships among at least one of circulation regions, evacuation routes, occupancy regions, stair regions, elevator regions, service regions, or usable floor areas.

19. The system of claim 16, wherein the one or more processors are configured to suppress generation of a floor-plan object for a candidate structural building configuration determined to violate at least one of a structural-span limitation or an evacuation-route limitation.

20. The system of claim 16, wherein the one or more processors are configured to rank the remaining candidate structural building configurations according to at least one of rentable-area ratio, material utilization, construction cost, operating efficiency, compliance margin, energy efficiency, anticipated revenue, or projected profitability.
